(19) United States
(12) Patent Application Publication
(10) Pub. No.: US 2005/0060933 A1
(43) Pub. Date: Mar. 24, 2005

(54) Horticultural container lining for enhancing contained soil's water absorption

(76) Inventor: David Lee Henson, Northfield, MN (US)

Correspondence Address: David L. Henson, PO Box 487, Northfield, MN, 55057, US

(21) Appl. No.: 10/922,552

(22) Filed: Aug. 20, 2004

Related U.S. Application Data
(60) Provisional application No. 60/497,151, filed on Aug. 22, 2003.

(51) Int. Cl. A01G 9/02

(52) U.S. Cl. 47/80

(57) ABSTRACT

A natural fiber lining material (10) for horticultural containers (16) which is placed below soil (14) and will not absorb or release water (30) until soil is saturated with water.

### CROSS-REFERENCE TO RELATED APPLICATIONS

This application claims the benefit of PPA Ser. No. (APPL No.) 60/497,151 filed Aug. 22, 2003 by the present inventor.

### FEDERALLY SPONSERED RESEARCH

Not Applicable

### SEQUENCE LISTING OR PROGRAM

Not Applicable

### BACKGROUND OF THE INVENTION

1. Field of Invention

This invention relates to horticultural containers, particularly those that allow drainage (wire baskets, plastic, clay, wooden or stone containers with holes).

2. Prior Art

In addition to the following background information I have included a published article of University of Minnesota trial results using my liner (“Kenaf, a New Basket Liner”) as well as a brochure describing the liner.

Horticultural containers have historically been produced to allow drainage of water to avoid root rot and “over watering” related problems. One category of container is open wire baskets lined with Moss or coconut fiber mats to enhance the beauty of the container and hold in the soil. A second category of container is closed plastic or clay containers with drainage holes. Both categories of containers tend to dry out when used by consumers having a detrimental effect on the plants.

When the soil is dry and water is applied the water runs quickly through the soil and out the bottom. The invention addressed in this patent filing is a natural fiber liner that is laid in the container below the soil. The liner initially repels water until the soil on it's surface reaches saturation, the liner then absorbs water and upon absorptive saturation releases excess water. The liner's delayed absorption allows the soil in the container time to uptake (or absorb) more water.

The first category of open wire baskets lined with coconut coir fiber or moss are too porous and drain too quickly for the soil to uptake and hold water. These liner materials also suffer from allowing excessive airflow causing drying. The invention described in this patent and presently manufactured from natural Kenaf fiber with a binder offers the natural appeal of coconut or moss lined baskets but increases the water held in a 14″ basket by as much as 80% (1.8 times). U.S. Pat. No. 6,725,599, 5454191, 5,363,592, 5,171,390, 5,070,645, 5,018,300, 4,528,774, 3,958,365, 3,818,633, 3,187,463, 2,848,842, 1,912,914 all concern themselves with either limiting the loss of water by reducing porosity or increasing the liners water holding capacity. My liner design is unique in that it maximizes the contained soil's water absorption prior to absorbing water into the liner and ultimately releasing excess water.

The second category of containers are solid plastic or clay with drainage holes and also drain faster than the soil can uptake its maximum amount of water. U.S. Pat. No. 5,860,249 and others have addressed this issue by adding various reservoir systems to contain excess water. Reservoir systems catch excess water but do increase the time soil is in contact with water. My liner invention allows the soil to fully saturate with water before releasing (or draining) excess water.

The additional water held in the soil dramatically benefits planted containers as can be seen in the attached published University of Minnesota trial results of my liner.

My liner assists in the conservation of water through less later flow off. The liner also reduces the need for fertilizers and water dissolved chemical enhancers, as less of these additives are lost in excessive draining.

My basket liner is offered in a convenient sheet form that when wet can be applied to complex wire forms and remain in the complex shape. Coconut coir fiber is very stiff with a memory and wants to spring back into original sheet form. Moss when applied is very labor intensive and messy with a tendency to drop.

### BACKGROUND OF INVENTION—OBJECTS AND ADVANTAGES

Accordingly, besides the objects and advantages of the basket liner described in my above patent, several objects and advantages of the present invention are:
(a) to provide a liner sheet material for horticultural containers that limits water drainage until the soil reaches saturation;
(b) to provide a natural fiber liner for hanging wire baskets that enhances soil saturation;
(c) to provide a natural fiber liner that allows limited airflow to roots;
(d) to provide a natural fiber liner that enhances soil hydration while resisting to mold or mildew;
(e) to provide a natural fiber liner that absorbs water into the liner material;
(f) to provide a natural fiber liner that conforms to complex wire topiary shapes and holds form;
(g) to provide natural fiber liner material that is soft and capable of being cut with sissors;
(h) to provide a natural fiber liner manufactured from a crop that can be grown throughout the world—Kenaf fiber;
(i) to provide a natural fiber liner manufactured from Kenaf fiber;
(j) to provide a natural fiber liner from Kenaf fiber that has been allowed to ret in the field.

Further objects and advantages are to provide my liner material in precut sizes to fit various size horticultural containers. The liner material will also be sold in rolls for the purpose of custom cuts lengths being offered to fill unusual container sizes and shapes. Still further objects and advantages will become apparent from a consideration of the ensuing description and drawings.

### SUMMARY

In accordance with the present invention a liner comprises a fibrous mat held together with a binder cut to fit various sized horticultural applications.

In the drawings, closely related figures have the same number but different alphabetic suffixes.

FIG. 1 shows fibrous strands that when bound together comprise the liner.

FIG. 2 shows a preformed section of liner material when bound together.

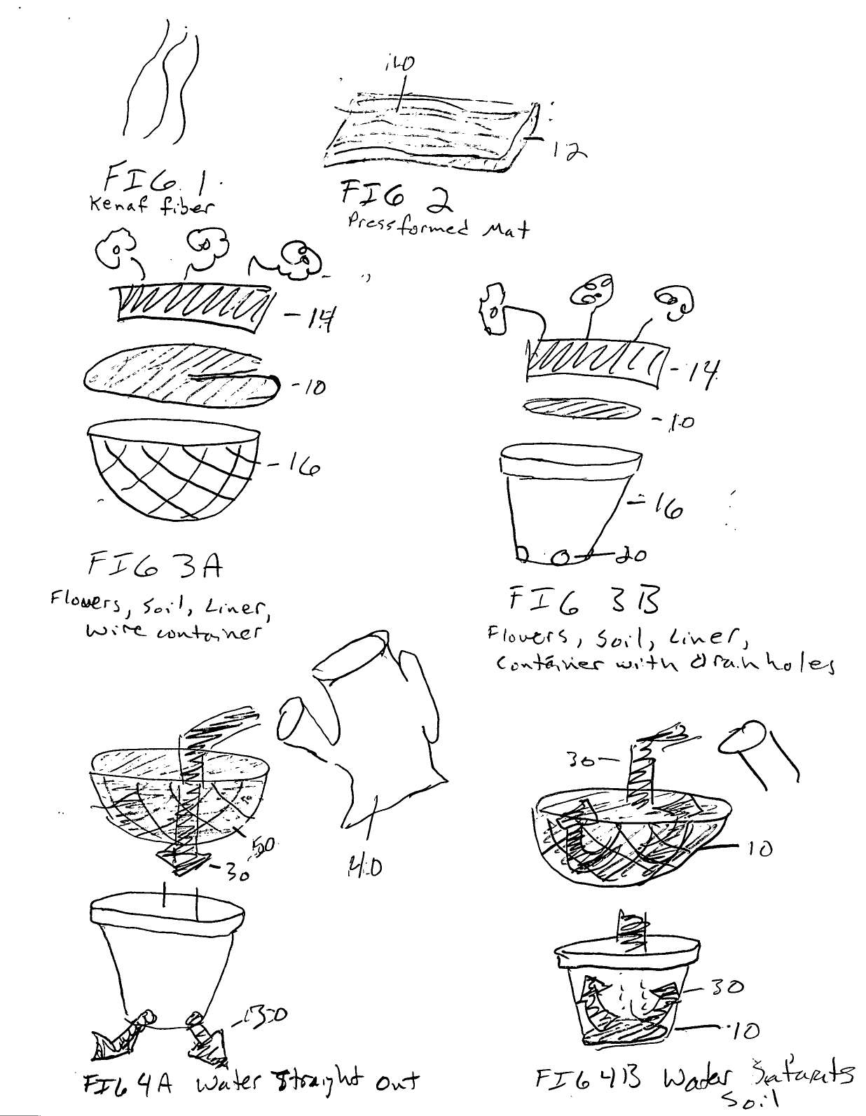

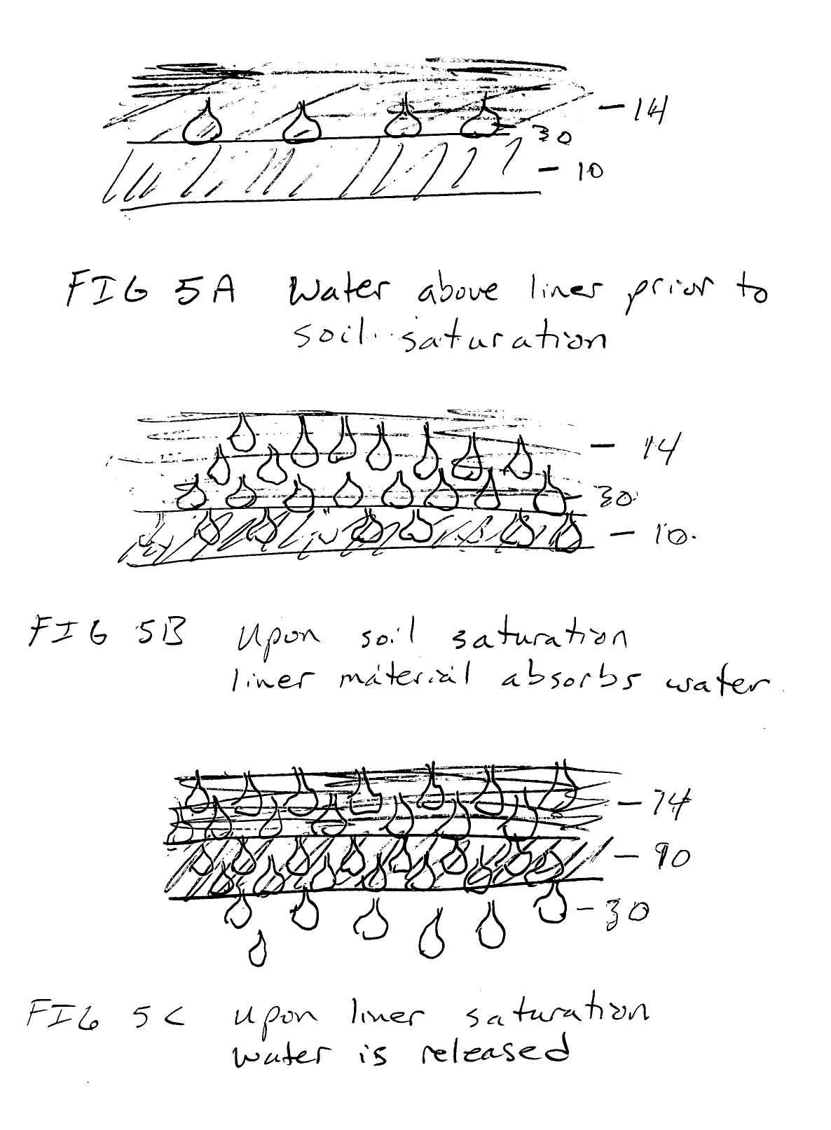

FIG. 3A shows a wire horticultural container assembly of plants, soil, liner and wire container.

FIG. 3B shows a solid walled horticultural container assembly of plants, soil, liner and solid container with drainage holes.

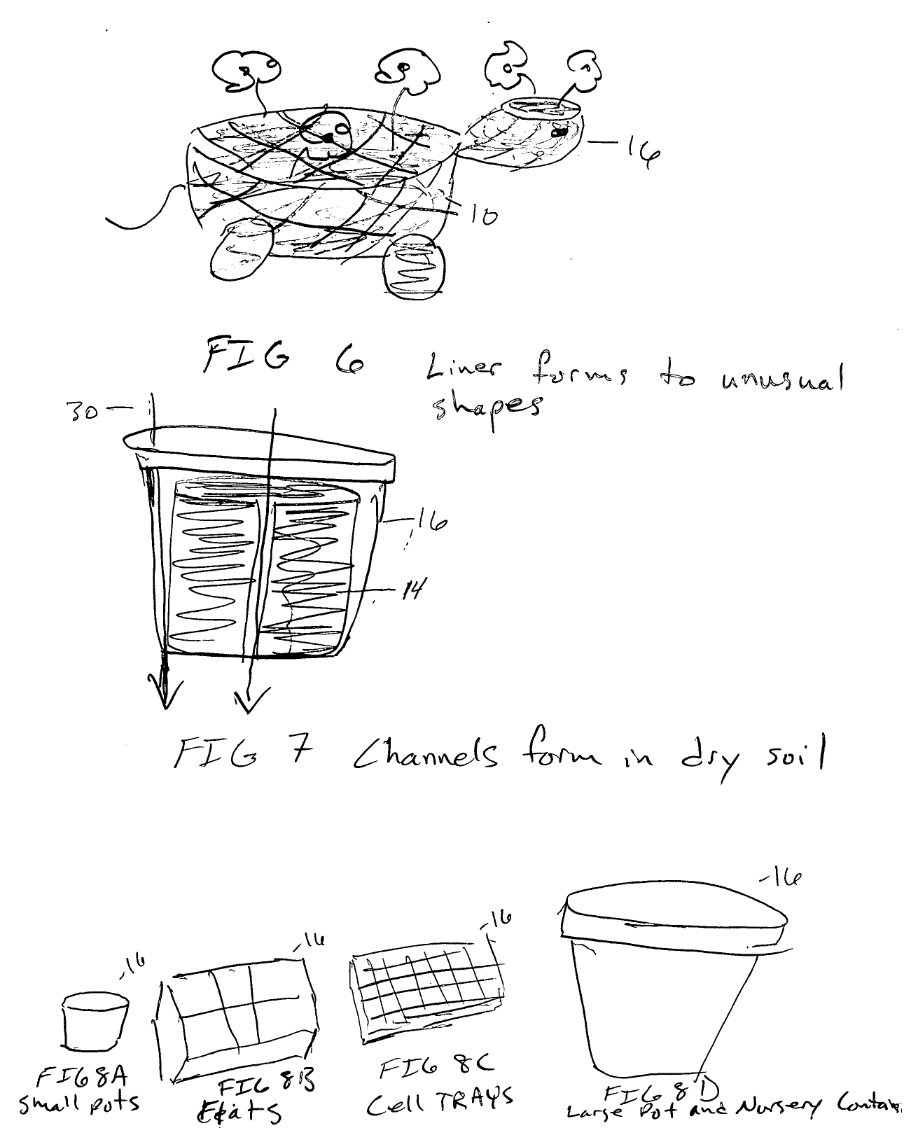

FIG. 4A shows a diagram of water flowing through a porous coco or moss material.

FIG. 4B shows a diagram of my liner holding water above material prior to soil saturation.

FIG. 5A shows water held above liner when soil is holding minimal moisture.

FIG. 5B shows water entering liner material when soil has become saturated with water.

FIG. 5C shows water being released through the liner when the liner and soil have become saturated with water.

FIG. 6 shows the liner conformed to unusual shaped form.

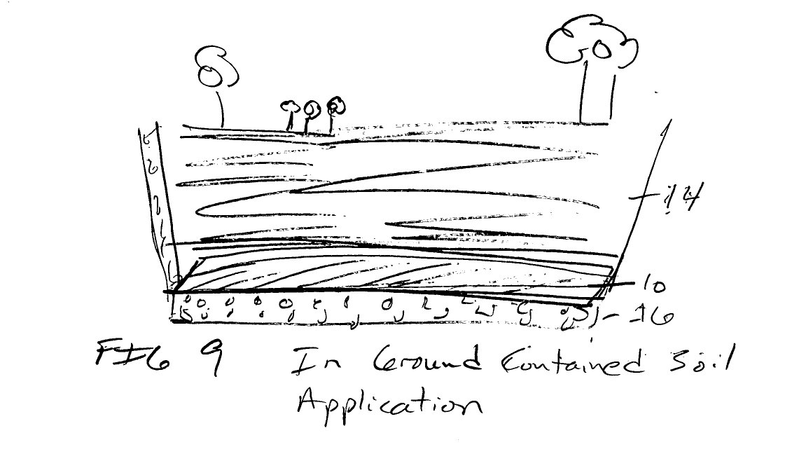

FIG. 7 shows channels formed in soil, which create a path for water and impair future hydration without the benefit of my liner.

FIGS. 8A to 8D show a broad spectrum of horticultural containers that my liner will Enhance

FIG. 9 shows the liner functionality can be applied to “in ground” containers in landscape and garden environments

### DRAWINGS REFERENCE NUMERALS

10 formed liner material 12 side profile of material
14 container soil 16 horticultural container
20 drainage holes 30 water
40 watering can 50 inferior lining material

### DETAILED DESCRIPTION—FIGS. 2 AND 3 COMPONENT 10—PREFERRED EMBODIMENT

A preferred embodiment of the present invention is illustrated in FIG. 2 (formed liner material) and FIG. 3 Component 10 (liner material precut to shape). The liner is manufactured from a fibrous material with appropriate absorptive properties such as Kenaf fibers. Kenaf or like fibers are mixed with a chemically stable binding fiber that resists attack by oils, solvents, weak acids or weak alkalis. Copolyolefin Bicomponet fiber (81% polyethylene terephthsalte core) would represent a typical example of binder fiber. A typical relationship would be a mixture 92% Kenaf like fibers with 8% Copolyolefin Bicomponet fibers. Currently the use of field ret Kenaf fiber is found to offer the best coloration and absorbtive properties.

The fibrous mixture is then run through an industrial blanket former where the material is spread out, run through an oven at temperatures appropriate to set the binder fiber and press formed into liner material. Typical thickness of the processed liners would be ⅛″ to 1″ inch. The density is defined such that droplets of water when applied are not absorbed but when the surface is saturated with water that water is absorbed into the material.

The liner material is then rolled up into 5′×50′ or as needed sizes to be cut into shapes appropriate for horticultural containers or sliced into bulk size rolls appropriate to custom cutting at garden centers or greenhouse, typically 2′ and 3′ by 50′ rolls.

Detailed embodiments of typical horticultural container shapes are show in enclosed brochure entitled Kenaf-Liner. FIGS. 8A-8D show a sample of the wide range of container that liner material would be cut to fit.

Advantages

From the description above the major design advantage of my liner becomes evident: the material is designed to facilitate the soil's saturation with water prior to the liner's saturation with water. Kenaf or Kenaf like fibers are also softer and faster to insert into containers in production environments than coconut coir liners. The wetted Kenaf liner material is hold the form of topiaries when lined as the fiber is not as stiff or hard as the coconut coir fiber.

Conclusion Ramifications and Scope

Accordingly, the reader can see that the natural fiber liner of this invention can be used to create healthier and more stable horticultural containers. The evidence of this can be seen in the included article publishing the University of Minnesota trial results of my liner “kenaf, a New Basket Liner.”

My liner material has exceptional advantages in that
the liner provides an attractive natural liner material for horticultural containers that limits water drainage until the soil reaches saturation;
the liner provides a natural fiber liner for hanging wire baskets that enhances soil saturation;
the liner allows limited but not excessive airflow to roots;
the natural fiber resists mold or mildew;
the liner that absorbs water into the liner material after the soil saturates;
the liner conforms to complex wire topiary shapes and holds form;
the liner material that is soft and capable of being cut with sissors;
the liner manufactured is currently manufactured from a crop that can be grown throughout the world—Kenaf fiber (Coconuts are not an appropriate crop for North America and most of Europe);
the liner manufactured from Kenaf fiber;
the coloration and performance are enhanced by currently using Kenaf fiber that has been allowed to ret in the field.

Although the description above contains many specificities, these should not be construed as limiting the scope of the invention but merely providing illustrations of some of the presently preferred embodiments of this invention. For example, the liner can be used under soil to enhance a myriad of horticultural container shapes and styles like: wire nursery baskets, wreath shapes, etc.

Thus the scope of the invention should be determined by the appended claims and their legal equivalents, rather than by the examples given.

1. A horticultural container lining that enhances contained soil's water absorption

2. The lining of claim 1 wherein said lining is composed substantially of fiber from the Kenaf plant.

3. The lining of claim 1 wherein said lining absorbs water only after said contained soil has saturated.

4. The lining of claim 1 wherein said lining drains water after said contained soil and said lining has saturated.

5. The lining of claim 1 wherein said lining is offered in precut shapes to fit various horticultural containers.

6. The lining of claim 1 wherein said lining is offered as a bulk roll for cutting of custom sizes and shapes.

7. The lining of claim 1 wherein said lining is soft enough to cut with household scissors.

8. The lining of claim 1 wherein said lining is natural esthetically pleasing fiber.

9. The lining of claim 1 wherein said lining conserves water requirements for said container.

10. The lining of claim 1 wherein said lining reduces said container's fertilizer and applied chemical runoff and requirements.

11. The lining of claim 1 wherein said lining provides aeration to root systems in said container.

12. A natural fiber lining for horticultural containers that requires soil saturation before draining.

13. The lining of claim 1 wherein said lining is composed substantially of fiber from the Kenaf plant.

14. The lining of claim 1 wherein said lining absorbs water only after said contained soil has saturated.

15. The lining of claim 1 wherein said lining drains water after said contained soil and said lining has saturated.

16. The lining of claim 1 wherein said lining is offered in precut shapes to fit various horticultural containers.

17. The lining of claim 1 wherein said lining is offered as a bulk roll for cutting of custom sizes and shapes.

18. The lining of claim 1 wherein said lining is soft enough to cut with household scissors.

19. The lining of claim 1 wherein said lining is natural esthetically pleasing fiber.

20. The lining of claim 1 wherein said lining conserves water requirements for said container.

21. The lining of claim 1 wherein said lining reduces said container's fertilizer and applied chemical runoff and requirements.

22. The lining of claim 1 wherein said lining provides aeration to root systems in said container.

23. A method of enhancing water absorption in horticultural contained soil (growing media), comprising:
(a) providing a fibrous lining material that absorbs water and drains only after said contained soil has absorbed more water than said soil would absorb in an identical situation without said method of lining.
(b) inserting said fibrous lining under contained soil

24. The method of claim 23 wherein said lining material is composed substantially of fiber from the Kenaf plant.

25. The method of claim 23 wherein said lining reduces said container's fertilizer and applied chemical runoff and requirements
